(19) United States
(12) Patent Application Publication
(10) Pub. No.: US 2004/0062807 A1
(43) Pub. Date: Apr. 1, 2004

(54) Biocide compositions and a method for their production

(76) Inventor: Grigori Pipko, Katzrin (IL)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/250,554

(22) PCT Filed: Dec. 30, 2001
(86) PCT No.: PCT/IL01/01215

(30) Foreign Application Priority Data
Jan. 2, 2001 (IL) 140695

(51) Int. Cl. A01N 59/16; A01N 59/06

(52) U.S. Cl. 424/486; 424/641; 424/692

(57) ABSTRACT

A biocide comosition useful for industrial materialsl comrising at least one metal oxide and at least one metal salt, wherein said at least one metal oxide is in a molar ratio of between 4:1 and 1:2 with said meal salt. The invention additionally relates to a process for roducing a biocide composition, comprising the steps of mixing a metal salt solution with at least one metal oxide in a molar ratio of between 4:1 and 1:2 oxide to salt and drying the resultant mixture thereby forming a cement powder.

### FIELD OF THE INVENTION

The present invention relates to biocide compositions. More specifically, the present invention relates to biocide compositions for incorporation into paints, coating, plasters, plastics, and other industrial materials and to a method for their production thereof.

### BACKGROUND OF THE INVENTION

Over the past decade, many advances have been made in the development high-quality, low cost, industrial materials, such as lumber, adhesives, coatings, petrochemicals, agrochemical compositions, paints, starches, proteinaceous materials, acrylic latex paint emulsions, and textiles. One problem encountered in the use of such industrial materials is the degradation of the material resulting from the growth of fungi, algae, and bacteria, occurring especially when the material is exposed to moisture or is submerged in water. To overcome this problem, a variety of biocides have been developed for use in different applications that aim to inhibit the growth of such microorganisms. For example, preservatives are typically used in water-based paint systems to prevent the growth of bacterial and fungal degradation during storage and shipment. Mildewcides are applied to prevent degradation of dried paint films and paint substrates. Antifoulants are primary used for protecting the surfaces of boats and ships.

U.S. Pat. No. 4,895,881 to Bigner describes a coating composition for boat hulls based on a combination of fluorocarbon polymers especially itself, and thus, they do not have to be applied separately. Furthermore, the active component of the composition is gradually released so that the biocide effect is maintained over a prolonged period of time.

The present invention provides a biocide composition useful for industrial materials at least one metal oxide and at least one metal salt, wherein said at least one metal oxide and said at least one metal salt are in a molar ratio of between 4:1 and 1:2 with said metal salt. Preferably, said at least one metal oxide comprises magnesium oxide and/or zinc oxide.

The active component used may include compounds of one or more elements belonging to the following groups of the periodical table: 2A (Be, Mg, Ca, Sr, and Ba), 3A (Sc, Y, La, Ce, Th), 4B (Ti, Zr, Hf), 5B (V, Nb, Ta, U), 6B (Cr, Mo, W), 7B (Mn, Tc, Re), 8 (Fe, Co, Ni), 1B (Cu, Ag, Au), 2B (Zn, Cd, Hg), 3A (B, Al, Ga, In, TI), 4A (C, Si, Ge, Sn, Pb), 5A (N, P, As, Sb, Bi), 6A (S, Se, Te), 7A (F, Cl, Br, I). The anion is preferably selected from the group consisting of: chlorides, nitrates, sulfates, carbohydrates and naphtenates, silicofluorides, fluorides, bromides, and iodides.

Preferably, the biocide composition is adapted to be applied as an active component in an industrial material at a weight of up to 100%. In paints and plastics, it is preferred that the composition be used at a weight of between 1-50%. In plasters, it is preferred that the composition be used at a weight of up to 100%.

Any appropriate additive, filler, pigment, etc, may be combined with the composition according to the application in which it is being used. For example, filler particles may be included that serve to improve the resistance or strength of the composition. Inorganic or organic materials may be employed, such as molten or sintered water resistant materials (for example, glass, ceramic materials, and metals), having any appropriate shape. The filler particles themselves may be antifouling agents, pigments, and/or carbon fluoropolymer included or bonded to the surface of the filler particle. In certain preferred embodiments of the present invention, an additive is selected from the group consisting of: phenols, chlorophenols, metal phenol salts, carbamates, thiocarbamates, azines, triazines, metalo azines, formaldehyde, formaldehyde derivatives, phenyl-urea compounds, halogenated hydrocarbones, antiseptic compounds, chlorohexidine, and cetrimide.

The present invention further relates to a process for producing a biocide composition, comprising the steps of mixing a metal salt solution with at least one metal oxide in a molar ratio of between 4:1 and 1:2 oxide to salt and drying the resultant mixture thereby forming a cement powder. Preferably, said step of drying is accomplished at a temperature of 80° C. for 2 hours.

According to certain preferred embodiments of the present invention, said at least one oxide comprises magnesium oxide and/or zinc oxide and said metal salt comprises magnesium chloride. Preferably, said magnesium oxide and said magnesium chloride are in a molar ratio of 1:1. Magnesium chloride maybe utilized as is from brines, for example, from the Dead Sea (Israel), Great Lakes (USA), Baskunchack (Russia), and Kahraboogaz (Azerbaigan).

In other preferred embodiments of the present invention, said at least one oxide comprises magnesium oxide and said metal salt comprises sodium tetraborate. Preferably, said magnesium oxide and said sodium tetraborate are in a molar ratio of 2:1.

Further in accordance with certain preferred embodiments of the present invention, the process further comprises the step of adding at least one additive. The additive is preferably selected from the group consisting of: phenols, chlorophenols, metal phenol salts, carbamates, thiocarbamates, azines, triazines, metalo azines, formaldehyde, formaldehyde derivatives, phenyl-urea compounds, halogenated hydrocarbones, antiseptic compounds, chlorohexidine, and cetrimide.

Moreover in accordance with certain preferred embodiments of the present invention, the oxide is selected from the group consisting of: cuprous oxide, zinc oxide, boric oxide, arsenic oxide, mercury oxide, argentum oxide, selenium oxide, tin oxide, and lead oxide.

In certain preferred embodiments of the present invention, the metal salt solution comprises Dead Sea (As Is) waters at a weight of up to 100%.

The present invention also relates to a biocide composition for use in an industrial material made by the process described above. The industrial material may be a paint, coating, plaster, or plastic, though it is appreciated that the composition may be used in other industrial materials as well. Furthermore, the biocide composition may be incorporated into the industrial material at a weight of up to 100%.

### DETAILED DESCRIPTION OF THE INVENTION

It is appreciated that the examples that follows are intended only to illustrate certain preferred embodiments of the present invention. They are in no way intended to limit the scope of the invention, as set out in the claims.

The following are preferred embodiments for a process for producing a cement having fungicidal or bacteriacidal activity, according to the present invention:

### EXAMPLE 1

40 g MgCl₂*6H₂O were dissolved in 40 ml de-ionized water. To the resultant solution, 50 g MgO, 30 g ZnO, 2.2 g KI solution (15% weight) and I₂ (5% weight) were added and mixed at 600 RPM for 30 minutes at room temperature. The mixture was then dried at 80° C. for 120 minutes.

### EXAMPLE 2

50 g MgCl₂*6H₂O were dissolved in 50 ml de-ionized water. To the resultant solution, 50 g ZnO were added and mixed at 600 RPM for 30 minutes at room temperature. The mixture was then dried at 80° C. for 120 minutes.

### EXAMPLE 3

50 g MgCl₂*6H₂O were dissolved in 50 ml de-ionized water. To the resultant solution, 60 g MgO and 50 g CuO2 were added and mixed at 600 RPM for 30 minutes at room temperature. The mixture was then dried at 80° C. for 120 minutes.

### EXAMPLE 4

50 g Na₂B₄O₇ were dissolved in 50 ml de-ionized water at 80° C. To the resultant solution, 60 g MgO were added and mixed at 600 RPM for 30 minutes at room temperature. The mixture was then dried at 80° C. for 120 minutes.

The resultant powders may be incorporated directly into paints, coatings, and plastics. The active ingredient is time-released so that the biocide activities are long lasting.

Experimental Data

Samples of unidentified mold were collected and placed on petri dishes with growth media having 5 different fungicide compositions in concentrations of 5%, 15%, and 25%. The fungus was allowed to grow at 25° C. for 3-5 days. At the end of this period, the diameter of the fungus on the plate was measured. All results were duplicated to assure accuracy.

TABLE 1
Growth of Fungus (CFU diameter)

| Composition | 5% | 15% | 25% |
|---|---|---|---|
| 1 | 6.5 cm | 4.5 cm | 1.2 cm |
| 2 | 6 cm | 1.5 cm | 1.5 cm |
| 3 | 3 cm | 2 cm | 1.2 cm |
| 4 | (no growth) | (no growth) | (no growth) |
| 5 | (no growth) | (no growth) | (no growth) |
| Calcium carbonate | 9 cm | 9 cm | 9 cm |
| Control | 9 cm | — | — |

Compositions:
1-100 g of 50% MgCl₂*6H₂O water solution and 36 g MgO, 0.15 g I₂
2-100 g of 50% MgCl₂*6H₂O water solution and 30 g MgO, 30 g ZnO
3-100 g of 50% MgCl₂*6H₂O water solution and 30 g MgO, 30 g methylene blue
4-100 g of 50% MgCl₂*6H₂O water solution and 30 g MgO, 30 g CuO
5-100 g of 50% Na₂B₄O₇*10H₂O water solution and 60 g MgO

In a second series of experiments, the growth of fungus spores was measured under the same conditions as those described above. The number of colonies were measured, again after 3-5 days of incubation. As is evidenced in the results, the fungicide in the growth media totally prevented germination of the spores in or on the media.

TABLE 2
Fungus Germination (CFU per ml)

| Composition | 5% | 15% | 25% |
|---|---|---|---|
| 1 | 0 | 0 | 0 |
| 2 | 0 | 0 | 0 |
| 3 | 0 | 0 | 0 |
| 4 | 0 | 0 | 0 |
| 5 | 0 | 0 | 0 |
| Calcium carbonate | 100 | 150 | 110 |
| Control | 130 | — | — |

(Compositions are same as those listed above)

### Table 3: Bacteria Germination (CFU per ml)

Germination of Gram positive Staphilococcus Aureus and Gram negative coliforms, in an appropriate nutrient agar in a Petri dish array (coliforms were grown in Voilet Red Bile Agar of Difco at 37° C. for 24 hours; S. Auereus were grown in Baird Parker Agar of Difco at 37° C. for 48 hours):

| | Weight | S. Aureus | S. Aureus | coliforms | coliforms |
|---|---|---|---|---|---|
| Composition | percentage | 10⁴ | 10³ | 10⁴ | 10⁴ |
| 1 | 1.5 | <100 | <100 | <10 | <10 |
| 2 | 1.5 | <100 | <100 | <10 | <10 |
| 3 | 1.5 | <100 | <100 | <10 | <10 |
| 4 | 1.5 | <100 | <100 | <10 | <10 |
| 5 | 1.5 | <100 | <100 | <10 | <10 |
| 6 | — | 3.2*10⁴ | 1.6*10³ | 1.2*10⁴ | 1.2*10³ |

Compositions:
1- 22 g of the solution composed of cetrimide 17% and chloroheximide 1%, and 23 g of 50% MgCl2 water solution and 30 g MgO and 30 g ZnO and 10 g CaCO3.
2- 2.2 g of the solution composed of ceramide 17% and chloroheximide 1%, and 30 g of 50% MgCl2 water solution and 30 gr MgO and 40 gr CaCO3.
3- 40 g of 50% MgCl2 water solution and 28 g MgO and 28 g ZnO and 8.4 g boric acid.
4- 40 g of 50% MgCl2 water solution and 25 g MgO and 25 g ZnO and 10 g calcium carbonate and 5% of solution of KI (15% weight) and I2 (5% weight)
5- 60 g of MgCl2 from 100% Dead Sea solution (Dead Sea waters As Is as a magnesium chloride source) and 50 g MgO.
6- Control, without biocide compositions

1. A non-toxic biocide cement composition adapted for being hydrolyzed for usage in an industrial material, said composition comprised of substantially all inorganic materials, and said composition comprising at least one metal oxide and at least one metal salt, wherein said at least one metal oxide is in a molar ratio of between 4:1 and 1:2 with said metal salt.

2. A non-toxic biocide cement composition according to claim 1, wherein said at least one metal oxide comprises magnesium oxide.

3. A non-toxic biocide cement composition according to claim 1, wherein said at least one metal oxide comprises zinc oxide.

4. A non-toxic biocide cement composition according to claim 1, wherein said at least one metal oxide comprises magnesium oxide and zinc oxide.

5. A non-toxic biocide cement composition according to claim 1, further comprising at least one additive.

6. A non-toxic biocide cement composition according to claim 5, wherein the additive is selected from the group consisting of: phenols, chlorophenols, metal phenol salts, carbamates, thiocarbamates, azines, triazines, metalo azines, formaldehyde, formaldehyde derivatives, phenyl-urea compounds, halogenated hydrocarbones, antiseptic compounds, chlorohexidine, and cetrimide.

7. A process for producing a non-toxic biocide cement composition in an exothermic reaction, comprising the steps of mixing a metal salt solution with at least one metal oxide in a molar ratio of between 4:1 and 1:2 oxide to salt, and drying the resultant mixture thereby forming a cement powder, and hydrolyzing said cement powder for subsequent use in an industrial material.

8. A process according to claim 7, wherein said at least one oxide comprises magnesium oxide and zinc oxide and said metal salt comprises magnesium chloride.

9. A process according to claim 8, wherein said magnesium oxide and said magnesium chloride are in a molar ratio of 1:1.

10. A process according to claim 8, wherein the source of said magnesium chloride is brine used as is.

11. A process according to claim 7, wherein said at least one oxide comprises magnesium oxide and said metal salt comprises sodium tetraborate.

12. A process according to claim 11, wherein said magnesium oxide and said sodium tetraborate are in a molar ratio of 2:1.

13. A process according to claim 7, wherein the metal salt solution comprises Dead Sea waters at a weight of up to 100%.

14. A process according to claim 7, further comprising the step of adding at least one additive.

15. A process according to claim 7, wherein the additive is selected from the group consisting of: phenols, chlorophenols, metal phenol salts, carbamates, thiocarbamates, azines, triazines, metalo azines, formaldehyde, formaldehyde derivatives, phenyl-urea compounds, halogenated hydrocarbones, antiseptic compounds, chlorohexidine, and cetrimide.

16. A process according to claim 7, wherein said oxide is selected from the group consisting of: cuprous oxide, zinc oxide, boric oxide, arsenic oxide, mercury oxide, argentum oxide, selenium oxide, tin oxide, lead oxide, and magnesium oxide.

17. A biocide composition for use in an industrial material made by the process of claim 7, for use in paint, plaster, coating, or plastic.
